(19) United States
(12) Patent Application Publication
(10) Pub. No.: US 2005/0250457 A1
(43) Pub. Date: Nov. 10, 2005

(54) Radio diagnostic tool combining signal quality and signal strength measurement

(75) Inventors: Timothy G. Mester, Huntsville, AL (US); Matthew A. Kliesner, Madison, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., HUNTSVILLE, AL (US)

(21) Appl. No.: 10/839,496

(22) Filed: May 5, 2004

(51) Int. Cl. H04B 17/00

(52) U.S. Cl. 455/101

(57) ABSTRACT

A measure is derived of the potential alignment of radio antennas associated with wireless transceivers, that are interfaced with terrestrial communication links transporting digital communication signals between geographically spaced apart transceiver sites. At a first radio site, a received signal strength indication is derived for signals sourced from a second radio site geographically remote with respect to the first site. In addition, received signal quality is measured on signals sourced from the second site. A measure of how well a first radio antenna at the first site is aimed in the direction of a second radio at the second site is derived in accordance with the received signal strength indication and the received signal quality measurement.

### FIELD OF THE INVENTION

The present invention relates in general to telecommunication systems, and is particularly directed to a methodology for ensuring proper alignment of a pair of local and remote antenna systems employed by digital radio equipment used to wirelessly transmit digital communication signals interfaced therewith from land line transport media, such as fiber optic links, based upon received signal strength indication and received signal quality of signals being transmitted from a monitored remote antenna.

### BACKGROUND OF THE INVENTION

Present day data radios provide a wireless interface between some form of land line (e.g., a fiber optic cable-transported T1 system) and a freespace communication channel through which a pair of spaced apart data radios are linked. When the systems are initially deployed in the field, it is customary practice for the installing technician to attempt to align the radio's antenna by employing a received signal strength indicator (RSSI) to measure a peak in the signal being received. If the received signal strength is relatively strong (above some prescribed threshold), it is typically inferred that the antenna is pointed in the right direction toward the remote site antenna. Unfortunately, using RSSI as the sole measure of antenna alignment suffers when another RF signal source is present. Because the RSSI measurement is a peak power detection measurement, relying on this metric alone can lead the user to believe that the antenna dish is properly aligned and that the transceiver equipment being installed is receiving a good RF signal, when in fact, the signal being detected by the receiver equipment is an undesired signal from another source.

### SUMMARY OF THE INVENTION

In accordance with the present invention, this problem is effectively obviated by supplementing the RSSI measurement with a signal quality measurement. In particular, the invention augments the RSSI measurement with a signal-to-noise received signal quality (RSQ) measurement carried out on known data being sourced from the remote transmitter, and combines the results of the two measurements to ensure that the antenna is properly oriented. In particular, coupled with the RF head end of a respective RF receiver is a received signal strength indicator (RSSI) which produces a peak voltage measurement of the received and modulated RF signal. Accompanying this measurement is a received signal quality (RSQ) measurement, which is computed from the demodulated channel symbols. The received symbols are stored in an attendant memory, so that they may be accessed by the receiver's supervisory microcontroller to compute the ‘quality’ of the recovered data. For a QPSK system, signal ‘quality’ measurement is defined as:
Quality=mean(sqrt(I\hat{ }2+Q\hat{ }2))\hat{ }2/variance(I+Q),
where the terms ‘mean’ and ‘variance’ are used in their ordinary statistical measurement sense.

Examining both RSSI and Quality measurements reveals how well the two antennas at a pair of relatively remote sites have been aligned and are functioning once aligned. If the received signal is the desired signal, and it is being received at an acceptable power level, both the RSSI and RSQ readings will be maximum, indicating that the two radio antennas are properly aligned. Once the two antenna are aligned, if the RSSI output remains relatively high, but the RSQ reading drops to a low level, it may be inferred that there is a source of interference between the two sites. If the received signal is impaired by fading, both the RSSI and RSQ readings would be low.

### BRIEF DESCRIPTION OF THE DRAWINGS

FIG. 1 diagrammatically illustrates a wireless communication system having respective east site and west site radios that are interfaced with associated land lines (e.g., fiber optic cable-transported T1 system) and are used to transport digital data radio traffic over a freespace communication channel therebetween.

### DETAILED DESCRIPTION

Before describing the received signal strength and quality measurement based antenna alignment methodology in accordance with the present invention, it should be observed that the invention resides primarily in a modular arrangement of conventional communication electronic circuits and electronic signal processing circuits and components therefor. In a practical implementation that facilitates packaging in a hardware-efficient equipment configuration, these modular arrangements may be readily implemented as field programmable gate array (FPGA)-, or application specific integrated circuit (ASIC)-based chip sets. Consequently, the configuration of such an arrangement of circuits and components and the manner in which they are interfaced with one another have, for the most part, been illustrated in the drawings in readily understandable block diagram format, which show only those specific details that are pertinent to the present invention, so as not to obscure the disclosure with details which will be readily apparent to those skilled in the art having the benefit of the description herein. The block diagram illustrations are primarily intended to show the components of the invention in a convenient functional grouping, whereby the present invention may be more readily understood.

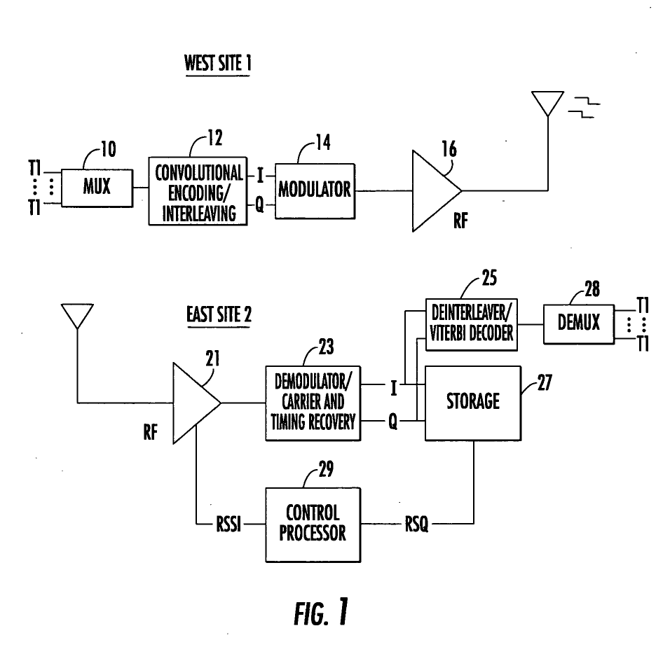

Attention is initially directed to FIG. 1, which is an overall block diagram of a T1 radio with which the present invention may be employed. As shown there, at a relatively ‘west’ or transmit site 1, there is an M:1 multiplexer 10 to which a plurality of T1 channels are applied. For the sake of simplicity in the present example, it may be assumed that each channel is a 1.544 Mbps channel. The output of M:1 multiplexer 10 is coupled to a convolutional encoder and interleaving unit 12, the output of which is encoded into IQ space (QPSK) and coupled to a modulator 14 for application to an RF unit 16, from which the encoded data stream is wirelessly transmitted to a relatively ‘east’ or receiver site 2.

At the receiver site 2, the wirelessly transmitted modulation is downconverter to baseband by an RF front end 21 and then supplied to a demodulator, carrier and timing recovery unit 23. Unit 23 produces respective I and Q channels that are supplied to a deinterleaver and Viterbi decoder unit 25, and to storage unit 27. The output of unit 25 is coupled to a demultiplexer 28 from which the T1 data is demultiplexed.

Coupled with the RF head end of a respective RF receiver is a received signal strength indicator (RSSI) which produces a peak voltage measurement of the received and modulated RF signal for application to control processor 29. Accompanying this measurement is a received signal quality (RSQ) measurement, which is computed from the demodulated channel symbols supplied by unit 23 to storage unit 27. Storage unit 27 provides the received quality (RSQ) information to control processor 29. The received symbols are stored in an memory, so that they may be accessed by the receiver's supervisory microcontroller 29 to compute the ‘quality’ of the recovered data.

For the QPSK system of the present example, signal ‘quality’ measurement is defined as:
Quality=mean(sqrt(I\hat{ }2+Q\hat{ }2))\hat{ }2/variance(I+Q)

In the above equation, the terms ‘mean’ and ‘variance’ are used in their ordinary statistical measurement sense.

Examining both RSSI and Quality measurements reveals how well the two antennas at the west and east sites have been aligned and are functioning once aligned. If the received signal is the desired signal, and it is being received at an acceptable power level, both the RSSI and RSQ readings will be maximum, indicating that the two radio antennas are properly aligned. Once the two antenna are aligned, if the RSSI output remains relatively high, but the RSQ reading drops to a low level, it may be inferred that a source of interference has been deployed between the two sites. If the received signal is impaired by fading, both the RSSI and RSQ readings would be low.

While we have shown and described an embodiment in accordance with the present invention, it is to be understood that the same is not limited thereto but is susceptible to numerous changes and modifications as known to a person skilled in the art. We therefore do not wish to be limited to the details shown and described herein, but intend to cover all such changes and modifications as are obvious to one of ordinary skill in the art.

1. A method of deriving a measure of the potential alignment of radio antennas associated with wireless transceivers that are interfaced with terrestrial communication links for the transport of digital communication signals between geographically spaced apart transceiver sites, said method comprising the steps of:
(a) at a first site, monitoring received signal strength indication of signals sourced from a second site geographically remote with respect to said first site;
(b) at said first site, measuring received signal quality of signals sourced from said second site; and
(c) deriving a measure of how well a first radio antenna at said first site is aimed in the direction of a second radio at said second site in accordance with the received signal strength indication monitored in step (a) and with the received signal quality measured in step (b).

2. The method according to claim 1, wherein step (c) comprises, in response to the received signal strength indication monitored in step (a) and the received signal quality measured in step (b) exceeding associated thresholds associated therewith, maintaining the aiming direction of said first antenna toward said second site.

3. The method according to claim 1, wherein step (c) comprises, in response to the received signal strength indication monitored in step (a) exceeding an associated RSSI threshold, but in response to said received signal quality measured in step (b) failing to exceed an associated RSQ threshold, inferring that said first antenna is pointed at a source of interference.

4. The method according to claim 1, wherein step (c) comprises, in response to the received signal strength indication monitored in step (a) failing to exceed an associated RSSI threshold, and in response to said received signal quality measured in step (b) failing to exceed an associated RSQ threshold, inferring that the first antenna is not well pointed, and adjusting the pointing direction of said first antenna so as to increase the received signal strength indication and the received signal quality measurement.

5. The method according to claim 1, wherein step (c) comprises, in response to the received signal strength indication monitored in step (a) failing to exceed an associated RSSI threshold, and in response to said received signal quality measured in step (b) exceeding an associated RSQ threshold, inferring that the first antenna is not precisely aligned, and moving the pointing direction of said first antenna so as to increase the received signal strength indication.

6. A system of deriving a measure of the potential alignment of radio antennas associated with wireless transceivers that are interfaced with terrestrial communication links for the transport of digital communication signals between geographically spaced apart transceiver sites, said system comprising:
at a first site,
a received signal strength indicator which is operative to monitor received signal strength of signals sourced from a second site geographically remote with respect to said first site;
a signal quality measurement device which is operative to measure received signal quality of signals sourced from said second site; and
a signal processor which is operative to derive a measure of how well a first radio antenna at said first site is aimed in the direction of a second radio at said second site in accordance with the received signal strength indication monitored by said received signal strength indicator and with the received signal quality measured by said signal quality measurement device.

7. The system according to claim 6, wherein said signal processor is operative, in response to the received signal strength indication and the received signal quality measurement exceeding associated thresholds associated therewith, to indicate that the aiming direction of said first antenna toward said second site should be maintained.

8. The system according to claim 6, wherein said signal processor is operative, in response to the received signal strength indication exceeding an associated RSSI threshold, but in response to said received signal quality failing to exceed an associated RSQ threshold, to indicate that said first antenna is pointed at a source of interference.

9. The system according to claim 6, wherein said signal processor is operative, in response to the received signal strength indication failing to exceed an associated RSSI threshold, and in response to said received signal quality failing to exceed an associated RSQ threshold, inferring that the first antenna is not well pointed, to indicated that an adjustment of the pointing direction of said first antenna is necessary in order to increase the received signal strength indication and the received signal quality measurement.

10. The system according to claim 6, wherein said signal processor is operative, in response to the received signal strength indication failing to exceed an associated RSSI threshold, and in response to said received signal quality exceeding an associated RSQ threshold, to indicate that the first antenna is not precisely aligned, so that the pointing direction of said first antenna may be moved so as to increase the received signal strength indication.
